(19) United States
(12) Patent Application Publication
(10) Pub. No.: US 2025/0312975 A1
(43) Pub. Date: Oct. 9, 2025

(54) SYSTEM FOR PLATELESS MAGNETIC INDUCTION WELDING OF ROOFING MEMBRANES

(71) Applicant: CARLISLE CONSTRUCTION MATERIALS, LLC, Carlisle, PA (US)

(72) Inventors: Gregory MOUNTAIN, Newville, PA (US); Sunil RAMACHANDRA, Lancaster, PA (US); Jordan OLIVIO, Carlisle, PA (US)

(73) Assignee: CARLISLE CONSTRUCTION MATERIALS, LLC, Carlisle, PA (US)

(21) Appl. No.: 18/901,864

(22) Filed: Sep. 30, 2024

Related U.S. Application Data
(60) Provisional application No. 63/574,625, filed on Apr. 4, 2024.
(60) Provisional application No. 63/645,682, filed on May 10, 2024.

(51) Int. Cl. B29C 65/36; B29C 65/00; B29K 105/16; B29K 105/20; B29K 105/26; B29K 505/00; B29L 31/10; B32B 7/04; B32B 27/08; B32B 27/18; B32B 27/32; E04D 5/10; E04D 5/14; H05B 6/10

(52) U.S. Cl. CPC B29C 65/3608; B29C 66/71; B32B 7/04; B32B 27/08; B32B 27/18; B32B 27/32; E04D 5/10; E04D 5/149; H05B 6/10; B29K 2105/16; B29K 2105/206; B29K 2105/26; B29K 2505/00; B29L 2031/108; B32B 2264/105; B32B 2272/00; B32B 2274/00; B32B 2419/06

(57) ABSTRACT

A system for using magnetic induction to weld roofing membranes together without having to use metal induction plates. One roofing membrane is formed with metal particles, a metal mesh or a metal layer therein. When a magnetic field is applied to this membrane, the metal will be heated, thereby causing the membrane to melt and fuse to a second (and optionally third) roofing membrane.

### PRIORITY APPLICATIONS

The present invention claims priority to U.S. Provisional Patent Application No. 63/645,682, entitled Recycled Roof Board, filed May 10, 2024 and to U.S. Provisional Patent Application No. 63/574,625, also entitled Recycled Roof Board, filed Apr. 4, 2024, the entire disclosures of which are incorporated herein by reference in their entireties for all purposes.

### TECHNICAL FIELD

The present invention relates to systems that use magnetic induction to weld roofing membranes together.

### BACKGROUND OF THE INVENTION

Magnetic induction anchor plates are used to attach TPO roofing membranes onto the tops of roofing insulation boards. These plates (which are typically round discs) have the advantage of not puncturing the TPO roofing membrane and operate as follows. First, they are mechanically installed in an array formation on top of the insulation boards. Next, a TPO roofing membrane is spread out on top of these anchor plates. These anchor plates are each covered with a powdered metallic substance which (when magnetically heated) turns into an adhesive that secures the anchor plate to the bottom of the TPO membrane.

To locate these anchor plates below the TPO membrane, an operator passes a stand-up induction welding tool over the TPO membrane. The Rhino Bond® system sold by OMG, Inc. of Agawam, MA provides such a tool, and is described in detail in U.S. Pat. No. 10,925,124 and 8,492,683. This tool has sensor coils that detect the presence of the anchor plates below the membrane. When an anchor plate has been detected, the tool then uses magnetic induction to heat a heat-activated adhesive that covers the top of each anchor plate. When heated, the anchor plate's adhesive is then thermally welded to the bottom of the TPO membrane.

Although the Rhino Bond® system (and similar induction welding systems generally) have been found to be a fairly good solution, one big limitation is that the TPO membrane is only attached to the top of the insulation boards at those locations where the induction plates are present. In other words, the TPO roofing membrane is only secured to the roof at points disposed in an array formation across the roof.

It would instead be desirable to provide a system that uses magnetic induction heating, yet is somehow able to seal the TPO membrane to the roof or insulation boards along a long line or seam (i.e.: rather than at just discrete point locations above the anchor plates). An advantage of such long seam seals across the roof is that the final roofing membrane assembly would be connected to the roof at more locations and would therefore show increased resistance to high wind loads.

As will be further explained, the present system achieves its many advantages by using recycled post-consumer or post-industrial TPO roofing membranes. As such, the present system also relates to systems for recycling used thermoplastic polyolefin (TPO) roofing membranes, or roofing membranes made of other thermoplastics, into new building materials including roofing insulation facer and coverboard materials and wall sheathing coverboards.

When TPO roofing materials have finished their normal lifespan of use, they are simply removed from buildings and are sent into landfills. What would instead be desired would be systems for recycling these old TPO roofing membranes such that they are not simply discarded after they have reached the end of their operational lives. In short, finding a way to recycle TPO roofing membranes into desirable new building materials would cut down on landfill pollution.

Secondly, it would also be ideal if such recycled TPO membranes could be used in other building materials and applications. This would have the advantage of keeping the recycled TPO within the same basic industry. This would simplify supply chains since the same companies and building trades that are removing the old TPO membranes would be the same ones that would be using and installing these new recycled TPO materials.

As will be shown, the present invention provides a variety of different approaches to recycle old TPO roofing membranes for use in new roofing and new building applications (in addition to using such recycled TPO roofing membranes in plateless magnetic induction welding systems).

### SUMMARY OF THE INVENTION

The present invention is directed to a revolutionary improvement in using magnetic induction heating to weld thermoplastic roofing membranes together. To date, magnetic induction has only been used to heat adhesive-covered circular anchor plates that have been mechanically fastened onto a roof. In these systems, a roofing membrane is placed over these mechanically fastened circular anchor plates and a magnetic induction system is then used to heat the plates, thereby melting the adhesive on the plates which then sticks securely to the bottom of the roofing membrane above.

Although these magnetic induction plates solve the problem of using messy adhesive layers to secure the roofing membrane onto the roof, they have their own limitations. Specifically, the roofing membrane is only secured to the roof in the areas directly above these circular adhesive covered plates. It would instead be much more desirable to provide a system where a roofing membrane can be secured to the roof structure below along a line or seam (rather than just at the spaced-apart locations directly above these circular plates).

Unfortunately, to date, the only way that long roofing membrane seams can be made is either using adhesives below the membranes or simply heating the edges of overlapping roofing membranes to melt them together (which secures the adjacent roofing membrane edges together, but typically does not secure the roofing membranes to the roof assembly itself). As such, roofing installers must either use a layer of adhesives underneath the roofing membranes, or install magnetic induction anchor plates in an array across the roof. As stated above, a problem with using these circular anchor plates is finding them below the roofing membrane. Specialized machinery is required both to locate these individual plates and to magnetically heat them. What is instead desired is using less mechanical fasteners (which are a major cause of leaks) and using less adhesives (which is a messy approach).

As will be shown, the present system provides a magnetic induction heating approach that both avoids the use of adhesives and eliminates the need for adhesive-covered magnetic induction heating plates, as follows.

In a preferred aspect, the present system uses a novel approach to provide a first thermoplastic membrane that has metal deposited therein. Accordingly, when a magnetic field is applied to the first thermoplastic membrane, it heats the membrane causing it to fuse with a second thermoplastic membrane positioned thereover. Preferably, the first thermoplastic membrane is a TPO membrane that has been made from recycled post-consumer or post-industrial TPO using methods described herein. As such, the metal (being metal particles, a metal mesh or a metal layer) may be formed into the TPO membrane as part of the present novel recycling process.

In preferred aspects, the present system provides a roofing assembly configured for plateless magnetic induction welding, comprising:
a first thermoplastic roofing membrane having metal disposed therein;
a second thermoplastic roofing membrane in contact with the first thermoplastic roofing membrane, wherein magnetic induction welding of the first thermoplastic roofing membrane causes the metal in the first thermoplastic membrane to heat, thereby welding the second thermoplastic roofing membrane to the first thermoplastic roofing membrane.

Most preferably, the first thermoplastic roofing membrane (and optionally the second thermoplastic roofing membrane) is made of TPO with recycled post-consumer or post-industrial TPO therein. The metal in the thermoplastic membrane preferably comprises metal particles, a metal mesh or a metal layer.

In optional aspects, the first thermoplastic membrane may comprise stacked layers of TPO welded together. Preferably as well, each of these layers may be made separately and include recycled TPO therein. When the layers are made separately, and then individually fused together later, they may each have different amounts of metal deposited in them. This is desirable since the layer of this composite membrane that is in direct contact with the second thermoplastic membrane preferably has the highest concentration or amount of metal in it. Layers that are farther away may have less metal or no metal at all therein. As such, metal is conserved and only supplied where it is actually needed.

In preferred aspects, the first thermoplastic membrane (having metal therein) may be a facer, coverboard, nailboard or insulation coverboard which is preferably made from recycled TPO. Optionally, however, the second thermoplastic membrane may also have metal disposed therein.

The present system may also include an optional third thermoplastic roofing membrane in direct contact with the first and second thermoplastic roofing membranes. The edges of the second and third thermoplastic roofing membranes may be positioned to overlap while sitting on top of the first thermoplastic roofing membrane. When a magnetic field is applied, the metal in the first thermoplastic membrane will be heated, thereby heating the first thermoplastic membrane, welding the edges of the second and third thermoplastic membranes together. Moving the magnetic field along the edges will seam the edges together, while also welding each of the second and third roofing membranes to the heated first roofing membrane below.

The present system therefore also includes the method of plateless magnetic induction welding of roofing membranes, comprising:
providing a first thermoplastic roofing membrane having metal therein;
providing a second thermoplastic roofing membrane, and placing the second thermoplastic membrane on top of the first thermoplastic roofing membrane; and then
applying a magnetic field to the first thermoplastic membrane to heat the metal, thereby causing the first and second thermoplastic membranes to be welded together.

### BRIEF DESCRIPTION OF THE DRAWINGS

FIG. 1 is a block of roof building material containing recycled TPO made according to the present method.

FIG. 2 is a block of roof building material containing recycled TPO as seen in FIG. 1 laminated onto a block of insulation material.

FIG. 3 is a sectional side elevation view of a TPO roofing membrane being magnetically induction welded onto the top of the assembly of FIG. 2.

FIG. 4 is a perspective illustration showing overlapping side edges of a pair of TPO roofing membranes being magnetically induction welded together onto the top of the assembly of FIG. 2.

FIG. 5 is an illustration of a plurality of TPO membranes having recycled content being stacked together to form a building material containing recycled TPO made according to an aspect of the present system.

FIG. 6 is a sectional side elevation view of a TPO roofing membrane being magnetically induction welded onto the top of the assembly of FIG. 5.

### DETAILED DESCRIPTION OF THE DRAWINGS

### (a) Overview

The present invention provides a system for magnetic induction welding of roofing membranes without requiring standard adhesive-covered magnetic induction anchor plates. Instead of relying on these standard magnetic induction anchor plates, the present revolutionary system instead provides novel roofing building materials having metal particles, meshes or other metal elements pre-fabricated therein. As will be explained, this is accomplished by manufacturing the present novel building materials to incorporate recycled post-consumer or post-industrial TPO.

### (b) The Present Recycled Roof Material

The present invention provides several different building materials and ways to make new building materials (preferably including insulation facer materials, insulation coverboards, nailboards, wall sheathing boards, and systems thereof) from recycled TPO roofing membranes or from other thermoplastic roofing membranes. These approaches are discussed in U.S. Provisional Patent Application No. 63/645,682, entitled Recycled Roof Board, filed May 10, 2024 and to U.S. Provisional Patent Application No. 63/574,625, also entitled Recycled Roof Board, filed Apr. 4, 2024, the entire disclosures of which are incorporated herein by reference in their entireties for all purposes.

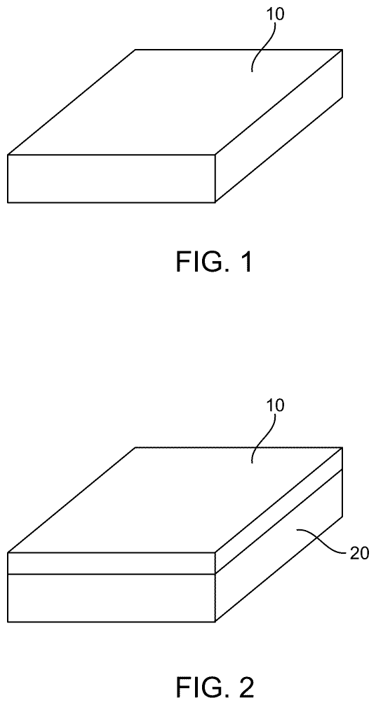

FIG. 1 shows a block or substrate 10 of roof building material containing recycled TPO made according to the present system, and as described in Provisional Patent Applications 63/645,682 and 63/574,625.

In one preferred aspect, the present system provides a building material product (block or substrate 10) and method of producing such product, by: supplying a shredded or granulated TPO material, wherein some of the shredded or granulated TPO material post-industrial or post-consumer use TPO material; and then heating and compressing the shredded or granulated TPO material to form a rigid building material. In preferred aspects, up to 20%, 20% to 60%, or 60% to 100% of the TPO may be post-industrial or post-consumer use TPO. The advantage of the present invention is that it both minimizes landfill pollution and also provides a new building material with superior properties as compared to other polymer based coverboard and facer products. This advantage is due to the presence of fibers which are either added to the product during production and/or are already naturally present in the roofing membranes which are initially used to produce the present products. As will be shown, the present products have multiple possible uses as construction materials in the building envelope. As will be explained, the present new building material is also preferably used in roofing applications (thereby keeping the new material within the roofing industry). One example of superior properties achieved by the present inventors was obtaining tensile strength failure of over 600 psi for thin embodiments of the material. These tensile failure strengths are much better than typically achieved with similar polymers alone. One example of woven fibers already present in the material (at the start of the present process) would be PET sandwiched into the center of a standard TPO roofing membrane sheet. Advantageously, such PET fibers will remain in the shredded or granulated TPO material that is used to make the present building material. These new building products (including facers and coverboards made from these materials) can optionally be produced by extrusion.

In some embodiments, the present building material comprises post-industrial or post-consumer use TPO mixed into new TPO (for example, from 40% to 80% new TPO and from 10% to 60% post-industrial or post-consumer use TPO). Other ranges are also possible and are included within the scope of the present invention. In some other embodiments, the present building material is formed from 100% post-industrial or post-consumer use TPO. It is to be understood that the present invention encompasses various sorts of mixtures with variable percentages of new and post-industrial or post-consumer use TPO. In preferred aspects, up to 20%, 20% to 60%, or 60% to 100% of the TPO may be post-industrial or post-consumer use TPO.

In other preferred embodiments, additional fiber reinforcement material can be mixed into the shredded or granulated TPO material prior to the heating and compressing step. This fiber reinforcement material may be PET or glass fiber, and may be shredded or granulated scrim from the post-industrial or post-consumer use TPO material. This fiber reinforcement material may be woven material that is shredded.

In other preferred embodiments, shredded or granulated PVC, EPDM, tire rubber PET, polyethylene, polypropylene, polystyrene, polyurethane may be mixed into the shredded or granulated TPO material prior to the heating and compressing step. Adding polystyrene has the advantage of reducing the weight of the final product and also contribute some fire retardancy. These advantages are especially enhanced if expanded polystyrene is used.

In other preferred embodiments, granulated or shredded insulation material may be mixed into the shredded or granulated TPO material prior to the heating and compressing step. In such cases, the granulated or shredded insulation material is preferably between 5% and 50% of the total weight of the building material, as higher amounts may tend to reduce the mechanical strength of the resulting material.

In other preferred embodiments, a solvent or water based adhesive binder may optionally be mixed into the shredded or granulated TPO material prior to the heating and compressing step.

In other preferred embodiments, additional fillers such as carbon black, calcium carbonate, clay, titanium dioxide, barium sulfate, and silica may be used to further increase the rigidity of the embodiments, alter the color of the material, and/or decrease the flammability of the material. It is to be understood that mixing one or more of these fillers is contemplated within the scope of the present invention.

In various uses, the new recycled TPO building material supplied by the present method described above may be used in different applications. For example, when the present material is supplied with a thickness of 0.010 and 0.080 inches, it can be attached to any of a polyisocyanurate, foamed polyurethane, expanded polystyrene, extruded polystyrene, glass fiber, mineral fiber, or aerogel insulation material such that the building material acts as an insulation facer.

In another application, the present material can be supplied with a thickness of 0.080 and 0.75 inches for use as a coverboard or nailboard. FIG. 2 shows a block or substrate 10 of roof building material containing recycled TPO as seen in FIG. 1 laminated onto a block of insulation material 20. This coverboard or nailboard 10 may optionally be used as a roofing coverboard or nailboard, or as a wall sheathing coverboard or nailboard.

In yet another application, the present material can be supplied with a thickness of 0.080 and 0.75 inches; and then factory laminated to any of a polyisocyanurate, foamed polyurethane, expanded polystyrene, extruded polystyrene, glass fiber, mineral fiber, or aerogel insulation material such that the building material acts as a composite insulation coverboard. Preferably, the present building material is laminated to the insulation to form the insulation coverboard. Factory lamination saves applicators valuable time as opposed to field applying separate insulation and coverboard layers in the roofing or wall assembly.

In further embodiments, the present material (when operating either as a facer or coverboard) can be textured to increase friction for foot traffic thereon or to provide additional surface area for adhesives to bond thereto.

In further embodiments, a sacrificial film which may be a polyethylene film with a rubber based pressure sensitive adhesive (such as APEEL™, made by Carlisle Construction Materials of Carlisle, Pennsylvania) can be added on top of the present facer or coverboard to protect the material from getting dirty during installation.

In preferred methods, the temperature that is used is sufficiently high to melt the TPO, but not melt its PET reinforcing scrim. The melting point of TPO is approximately 320 F and the PET melting point is approximately 500 F. Therefore, temperatures between 320 and 490 F are preferably used in accordance with the present system. In cases where glass reinforcement is used in the TPO (as opposed to PET), preferred temperatures over 320 F would be sufficient. This is because glass melting temperature is so high that such temperatures would simply burn the TPO, and therefore such high temperatures would not be attempted.

Shredding of the TPO results in cut flakes that have “hairy” PET scrim protrusions extending out of the cut ends. This is advantageous because these hairy frayed ends provides excellent reinforcement when the material is heated and pressurized to be melted together. As such, this approach is preferred to simply cutting the TPO to have clean edges (for example, cutting with blades or scissors).

The present recycled content TPO building material can be built to different thicknesses and these different thicknesses have different preferred uses.

In addition to comprising up to 20%, 20% to 60%, or 60% to 100% of the TPO may be post-industrial or post-consumer use TPO and optional new TPO, the present building material may also comprise other additions, offering other benefits, as follows.

The present recycled TPO building material may be made by optionally mixing fiber reinforcement material into the shredded or granulated TPO material prior to the heating and compressing step. This fiber reinforcement material may optionally be PET or glass fiber. For example, the fiber reinforcement material may be shredded or granulated scrim (including woven scrim) from the post-industrial or post-consumer use TPO material. The benefit of adding fiber reinforcement material is that the resulting building product will itself be stronger. The benefit of using the scrim from the old TPO is that it is not necessary to separate the scrim out of the recycled TPO. Instead, the old (now shredded) scrim layer which was initially in the old TPO membrane is now used to give strength to the present new recycled TPO building material. Existing recycling systems tend to rely on extrusion and the presence of PET scrim tends to get stuck in the processing machinery, leading to downtime. As a result, the old recycling approach was to attempt to remove as much of the PET scrim as possible. In contrast, the present system of recycling specifically uses the presence of PET scrim to its advantage.

In other preferred embodiments, the present recycled TPO building material may be made by optionally mixing one of granulated PVC, EPDM, tire rubber, PET, polyethylene, polypropylene, polystyrene or polyurethane into the shredded or granulated TPO material prior to the heating and compressing step. The advantage of this approach is that other common roofing materials may be added into the mixture prior to heating and compression to form the final building material. This has the advantage of reducing the amounts of these additional building materials that are typically just sent to landfills. This further reduces pollution.

In other preferred embodiments, the present recycled TPO building material may be made by optionally mixing granulated or shredded insulation material into the shredded or granulated TPO material prior to the heating and compressing step. Such granulated or shredded insulation material may preferably be between 5% and 50% of the total weight of the building material. This advantage of this approach is that it reduces the amount of insulation that is sent to landfills.

In optional preferred embodiments, a solvent or water based adhesive binder may be mixed into the shredded or granulated TPO material prior to the heating and compressing step. This has the advantage of making the recycled TPO building material hold together better. The use of an adhesive in the field can result in result in paper insulation facer and/or fiberglass insulation facer still being stuck to the TPO membrane at the start of the present recycling process (i.e.: prior to shredding the TPO). As a result, materials that may be present in the recycled TPO material include small amounts of paper, fiberglass, foil, etc. that can amount to up to 5% by weight of the total material. Normally, these materials are simply contaminated by the use of the adhesives and are therefore currently very difficult to recycle. As a result, they currently must be discarded because they are too hard to process and put into any common recycling streams. In contrast, however, in accordance with the present system, these paper, fiberglass, and foil materials can simply be included directly into the recycling process when forming the present building material.

In addition to providing novel building materials made from recycled post-industrial or post-consumer TPO membranes, the present invention further provides novel products and uses that incorporate these novel building materials. In many cases, the preferred uses of the building material corresponds to the thickness of the manufactured building material. This is advantageous in that using a greater volume of old TPO material results in a reduced TPO sent to landfills as well as yielding new building products.

In one preferred embodiment, the present system provides a method of making an insulation facer. This is accomplished by supplying the present building material with a thickness between 0.010 and 0.080 inches; and then attaching the building material to any of a polyisocyanurate, foamed polyurethane, expanded polystyrene, extruded polystyrene, glass fiber, mineral fiber, or aerogel insulation material such that the building material acts as an insulation facer. It is to be understood that the present building material can itself be made using any of the methods disclosed herein.

In another preferred embodiment, the present system comprises a method of making a coverboard or nailboard. This is accomplished by simply supplying the present building material with a thickness between 0.080 and 0.75 inches for use as a coverboard or nailboard. The coverboard or nailboard so manufactured is advantageously very versatile and can be used as a roofing coverboard or nailboard or as a wall sheathing coverboard or nailboard, as desired.

In another preferred embodiment, the present system comprises a method of making an insulation coverboard. This is accomplished by supplying the present building material with a thickness between 0.080 and 0.75 inches; and then attaching the building material to any of a polyisocyanurate, foamed polyurethane, expanded polystyrene, extruded polystyrene, glass fiber, mineral fiber, or aerogel insulation material such that the building material acts as an insulation coverboard. In these embodiments of the invention, the building material may be laminated to the insulation to form the insulation coverboard. Alternatively, the insulation may be foamed directly onto the present building material to provide an insulation with a coverboard thereon. Such foaming may use water or some other foaming material.

In each of the above described methods of making a facer, coverboard/nailboard or insulation coverboard, the present material can optionally be textured to increase friction for foot traffic thereon or to provide additional surface area for adhesives to bond thereto. In addition, a sacrificial film which may be a polyethylene film with a rubber based pressure sensitive adhesive (such as APEEL™, made by Carlisle Construction Materials of Carlisle, Pennsylvania) can be added on top of the facer or coverboard to protect the material from getting dirty during installation.

Also, in each of the above described methods of making a coverboard/nailboard or insulation coverboard, the present material can optionally include facers on its top and bottom made from different materials. Traditionally, top and bottom facers are made of the same material to prevent warping should the temperature change. In contrast, in accordance with the present system, the facers on the top and bottom can be made from different materials. To prevent these two facers from expanding and contracting to different amounts during temperature changes, the present system contemplates using a layered approach when designing the building material such that different layers are designed to have different thermal expansion properties. The advantage of this is that a cheaper facer (such as a paper) may be used on the bottom of the membrane.

In optional aspects, additives can be used to introduce foaming into the final product (in both of the above described shredded and stacked embodiments) to reduce the weight of the material and introduce some insulation properties into the final material. In preferred aspects, such additives may include, but are not limited to: water at 0.1-1% by wt. or chemical blowing agents such as azodicarbonamide, in ranges of 0.1%-2% by weight or Dinitrosopentamethylenetetramine in ranges of 0.2-3% by weight.

In other preferred embodiments, fillers including carbon black, calcium carbonate, clay, titanium dioxide, barium sulfate, or silica may be added to further increase the rigidity of the embodiments, alter the color of the material, and/or decrease the flammability of the building material.

In optional aspects, air pockets are formed into the material of block or substrate 10. These air pockets may be formed by residual moisture from the washing/shredding process that was left in the granules when the shredded flakes were heated and pressed together. One advantage of these optional air pockets would be for making the resulting building material lighter.

The herein described embodiments all refer to TPO. In accordance with alternate aspects of the present invention, materials other than TPO can be used as the base material for recycling in accordance with the present invention. For example, PVC, polyethylene, polypropylene, or other suitable thermoplastic material could be used. One advantage of using PVC as the base material is that the resulting PVC facers and coverboards are desirable products.

### (c) Metallic Particles and Plate-Less Magnetic Induction Welding

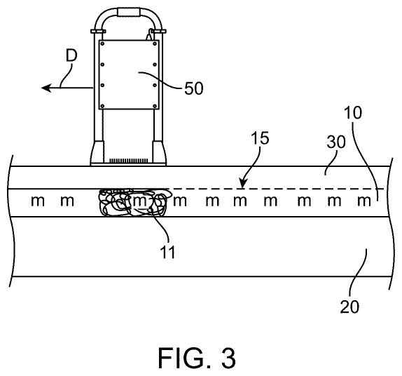

In further preferred embodiments, metallic particles may be included into the recycled building material itself in block or substrate 10 to facilitate plate-less induction welding. FIG. 3 is a sectional side elevation view of a TPO roofing membrane being magnetically induction welded onto the top of the assembly of FIG. 2. In accordance with this aspect of the invention, a magnetic induction heating system 50 (such as those described U.S. Pat. No. 10,925,124 and 8,492,683), is moved in direction D across the surface of a TPO roofing membrane 30 which has been placed on top of the assembly of FIG. 2. As such, system 50 causes the magnetic particles M in area 11 in building material 10 to heat, thereby melding the top of the block of building material 10 to the bottom of TPO roofing membrane 30. Slowly and continuously moving magnetic induction system 50 in direction D causes substrate 10 and roofing membrane 30 to melt together along path 15.

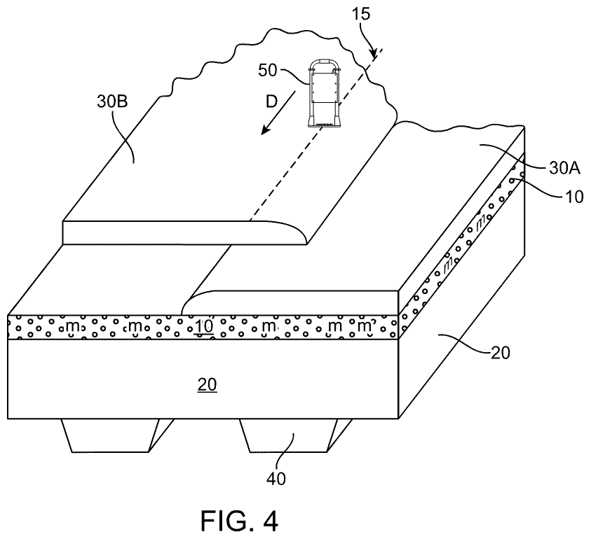

FIG. 4 is a perspective illustration showing overlapping side edges of a pair of TPO roofing membranes 30A and 30B being magnetically induction welded together over top of the assembly of FIG. 2. In this illustration, insulation block 20 is first installed on the top of a roof structure 40. The present novel building material 10 (which may be a coverboard) is then installed on top of insulation block 20. As set forth above, building material 10 has metal particles or elements M therein. A first thermoplastic roofing membrane 30A is placed on top of building material/coverboard 10. A second thermoplastic roofing membrane 30B is also placed on top of building material/coverboard 10, with the edges of membranes 30A and 30B overlapping. Next, magnetic induction system 50 is moved in direction D along the overlapping edges of roofing membranes 30A and 30B, thereby heating the metal particles M, in turn causing roofing membranes 10, 30A and 30B to melt and fuse together.

As such, it is to be understood that the present system of using magnetic induction heating system to heat metal particles or elements in a first thermoplastic membrane may be used either to weld two membranes together (i.e.: by heating a second roofing membrane placed on top of a first roofing membrane), or to weld three membranes together (i.e.: by heating second and third roofing membranes having their overlapping edges placed on top of the first roofing membrane).

When the thermoplastic roofing membranes are all made of TPO, the heat welding will weld both of the overlapping edges together and also weld each of the two pieces of thermoplastic roofing membrane directly to the insulation coverboard therebelow. This approach saves valuable time for installers and simplifies the roofing assembly by reducing or eliminating the need for adhesives and other means of chemical and physical attachment of the roofing membrane to the rest of the roofing system.

### (d) Multi-Layered Recycled Roofing Materials

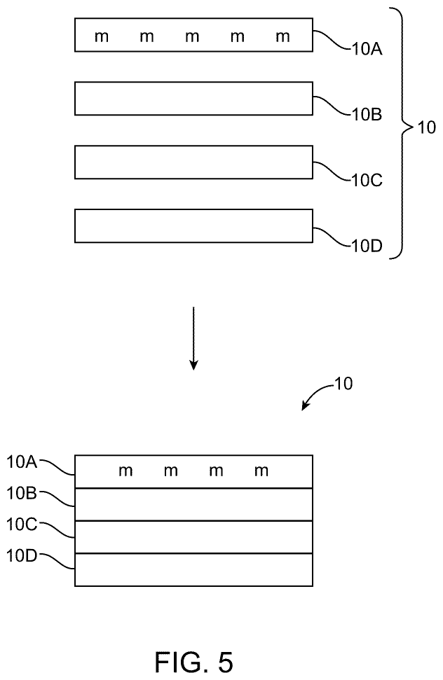

FIG. 5 is an illustration of a plurality of TPO membranes (10A, 10B, 10C and 10D) having recycled content being stacked together to form a building material 10 containing recycled TPO made according to an aspect of the present system. As such, the present invention also encompasses a method of making the present building material by stacking layers of TPO material, wherein some of the TPO material is post-industrial or post-consumer use TPO material; and then heating and compressing the stacked TPO material to form a rigid building material.

Similar to the first method, this second method of stacking layers of old TPO membranes can also include mixing any one of granulated PVC, EPDM, PET or polyurethane into the shredded or granulated TPO material prior to the heating and compressing step. This second method can optionally include mixing granulated or shredded insulation material into the shredded or granulated TPO material prior to the heating and compressing step (preferably in concentrations of between 5% and 50% of the total weight of the building material).

In preferred aspects, up to 20%, 20% to 60%, or 60% to 100% of the TPO may be post-industrial or post-consumer use TPO. Similar to the first described method above, granulated PVC, EPDM, PET or polyurethane or granulated or shredded insulation material may also be mixed into the stacked TPO material prior to the heating and compressing step. In this second method, the step of stacking layers of TPO material may be performed by stacking layers of TPO material having different colors such that a top surface of the building material has different color than a bottom surface of the building material. This has the advantage of providing either a dark or light material depending upon which side is facing up. This may be desired to better control the flash off time of adhesive products applied to the material. In optional preferred aspects, this approach may result in increases in the surface temperature on dark facers of up to 50 F, and may result in decreases in the surface temperatures on light facers up to 10 F below ambient temperatures. As such, the present approach may advantageously result in double adhesive flash off speeds on cooler days and four times faster adhesive flash off on warmer days.

A unique advantage of stacking layers of old and discarded TPO membranes is that old TPO layers that are white on top and black on their bottom may be stacked together. Then, under heat and compression, these layers can be fused together to yield the present building material. In addition, having some of the PET scrim material in the initial TPO membrane results in a natural fiber weave of the membrane in the final board product. The advantage of this stacked approach is that the roofing installer is provided with a final building material that has different colors on its top and bottom. Should the roofing installer want to install a light colored TPO membrane, (s) he simply turns the white side downwards. Conversely, should the roofing installer want to install a dark colored TPO membrane, (s) he simply turns the black side upwards. The advantage of having a TPO roofing membrane that can be darker or lighter as desired is that the membrane color affects the flash off time of adhesives applied to the building material membrane.

It is to be understood that these layers don't all have to be oriented the same direction. For example, the center layers can be placed with their black and white sides up and down in any order, provided that the top side of the very top membrane is differently colored than the bottom side of the bottommost membrane.

When assembling the present building materials out of multiple layers of material, the top (i.e.: outermost) layer can optionally be optimized for melt behavior while the layers below are optimized for mechanical strength. Optionally, these different layers can be co-extruded and then laminated together. Optionally as well, the various layers of TPO can be ultrasonically welded together, and/or be ultrasonically welded to a TPO coverboard or TPO facer layer.

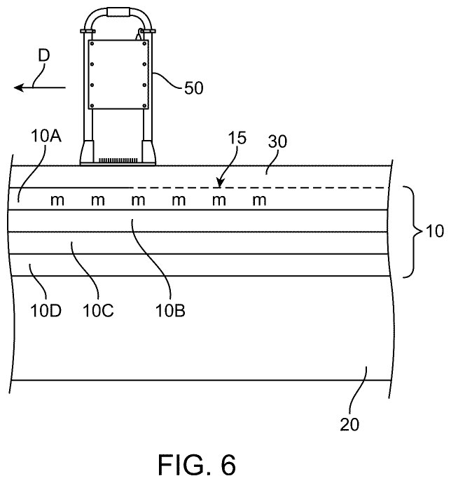

In preferred aspects, the metal elements M are only added to the top layer 10A in FIG. 5 when separate material layers 10A, 10B, 10C and 10D are initially formed. FIG. 6 is a sectional side elevation view of a TPO roofing membrane being magnetically induction welded onto the top of the assembly of FIG. 5, as follows.

In accordance with this aspect of the invention, a magnetic induction heating system 50 (such as those described U.S. Pat. No. 10,925,124 and 8,492,683), is moved in direction D across the surface of a TPO roofing membrane 30 which has been placed on top of the assembly of FIG. 5. As such, system 50 causes the magnetic particles M in area 11 in building material 10A to heat, thereby melding the top of the block of building material 10A to the bottom of TPO roofing membrane 30. Slowly and continuously moving magnetic induction system 50 in direction D causes top layer 10A of substrate 10 and roofing membrane 30 to melt together along path 15.

As seen in FIGS. 3 and 6, in each of the above described methods of making a facer, coverboard/nailboard or insulation coverboard 10, the present material can optionally include metallic particles to allow for plateless induction welding of the building material to a TPO facer or coverboard (or other) materials both above and below (for example, to TPO coverboards that have already been anchored to the building roof). The advantage of this approach is that it is then possible to induction weld at any desired location (as opposed to this only occurring at locations where induction welding plates have been pre-anchored). As such, welding continuously along a seam is possible, rather than only performing induction welding at pre-installed induction welding plates. A further advantage of this approach is that only the layer of the TPO membrane that contacts the second TPO membrane would have to have such a concentration of metallic particles therein. As such, metallic particles M would not need to be distributed evenly throughout the block or substrate 10 of building material. Instead, magnetic particles would only be required at those top or bottom layer locations where induction welding is actually occurring. This advantageously saves metallic materials as fewer metallic particles would be required.

What is claimed is:

1. A roofing assembly configured for plateless magnetic induction welding, comprising:
a first thermoplastic roofing membrane having metal disposed therein;
a second thermoplastic roofing membrane in contact with the first thermoplastic roofing membrane, wherein magnetic induction welding of the first thermoplastic roofing membrane causes the metal in the first thermoplastic membrane to heat, thereby welding the second thermoplastic roofing membrane to the first thermoplastic roofing membrane.

2. The roofing assembly of claim 1, wherein the first thermoplastic roofing membrane is made of TPO with recycled post-consumer or post-industrial TPO therein.

3. The roofing assembly of claim 1, wherein the metal within the first thermoplastic layer comprises metal particles, a metal mesh or a metal layer.

4. The roofing assembly of claim 2, wherein the TPO in the first thermoplastic membrane comprises stacked layers of TPO welded together.

5. The roofing assembly of claim 4, wherein the metal is disposed in a TPO layer positioned adjacent to the second TPO membrane.

6. The roofing membrane of claim 5, wherein a TPO layer that is not positioned adjacent to the second thermoplastic membrane does not have metal therein.

7. The roofing assembly of claim 1, wherein the first thermoplastic membrane is a facer, coverboard, nailboard or insulation coverboard.

8. The roofing assembly of claim 2, wherein the second thermoplastic membrane is made of TPO.

9. The roofing assembly of claim 1, wherein the second thermoplastic membrane has metal disposed therein.

10. The roofing assembly of claim 1, further comprising:
a third thermoplastic roofing membrane, the third thermoplastic roofing membrane being in direct contact with the first and second thermoplastic roofing membranes.

11. The roofing assembly of claim 10, wherein edges of the second and third thermoplastic roofing membranes overlap on top of the first thermoplastic roofing membrane, and wherein the edges form a seam when the metal in the first thermoplastic membrane below the seam has been heated by magnetic induction.

12. The roofing assembly of claim 11, wherein the first, second and third thermoplastic roofing membranes are made of TPO.

13. A method of plateless magnetic induction welding of roofing membranes, comprising:
providing a first thermoplastic roofing membrane having metal therein;
providing a second thermoplastic roofing membrane, and placing the second thermoplastic membrane on top of the first thermoplastic roofing membrane; and then
applying a magnetic field to the first thermoplastic membrane to heat the metal, thereby causing the first and second thermoplastic membranes to be welded together.

14. The method of claim 13, wherein the first thermoplastic roofing membrane is made of TPO with recycled post-consumer or post-industrial TPO therein.

15. The method of claim 13, wherein the metal in the first thermoplastic roofing membrane is only disposed at locations in the first thermoplastic membrane that are adjacent to the second thermoplastic roofing membrane.

16. The method of claim 13, wherein the TPO in the first thermoplastic membrane comprises stacked layers of TPO welded together.

17. The method of claim 13, further comprising:
placing a third thermoplastic membrane on top of the first thermoplastic membrane with an edge of the third thermoplastic membrane overlapping an edge of the second thermoplastic membrane; and then
applying the magnetic field to the overlapping edges of the first and second thermoplastic membranes, thereby welding the overlapping edges together.

18. The method of claim 17, wherein the first, second and third roofing membranes are made of TPO.
